(19) United States
(12) Patent Application Publication
(10) Pub. No.: US 2010/0299381 A1
(43) Pub. Date: Nov. 25, 2010

(54) Algorithm for the Adaptive Infinite Impulse Response Filter

(75) Inventor: Ky Minh Vu, Ottawa (CA)

Correspondence Address: Ky Vu, 3717 Sixth Street, Ottawa, ON, K1T 1K5, CA

(73) Assignee: AULAC TECHNOLOGIES INC., Ottawa (CA)

(21) Appl. No.: 12/783,555

(22) Filed: May 20, 2010

(30) Foreign Application Priority Data
May 25, 2009 (CA) CA2666292

(51) Int. Cl. G06F 17/10

(52) U.S. Cl. 708/322

(57) ABSTRACT

A new method to adjust the parameters of an adaptive Infinite Impulse Response (IIR) filter is suggested. The method adjusts the set of parameters of the pole polynomial of the filter. The parameters of the zero polynomial are calculated from the parameters of the pole polynomial. For efficiency, the pole polynomial is factored into a product of polynomials with at most quadratic order. To guarantee that the global minimum is achieved all the time, the algorithm ascertains that the new set of pole parameters gives smaller variance of the error than the set of pole parameters of the last adaptation time and the algorithm starts with the set of parameters that gives the global minimum.

### FIELD OF THE INVENTION

This invention relates to the adaptation of an adaptive Infinite Impulse Response (IIR) filter for system applications. The invention presents an algorithm to adjust the parameters of an adaptive IIR filter. The filter has two set of parameters. The algorithm adjusts them separately.

### BACKGROUND OF THE INVENTION

The art of adjusting the parameters of a model of a linear system on line and in real time is possible only with the advent of a digital computer or a computer chip. This fact makes the discrete controller and filter more popular than their continuous counterparts. For a discrete or digital filter, the IIR filter is the preferred filter because it has an infinite impulse response. It is, however, difficult to adapt its parameters because it has a rational transfer function. This fact spawns research for the best adaptive algorithm for its industrial applications.

There are a number of algorithms suggested for the adaptive IIR filter. In the academic circle, we see the Instrumental Variable (IV) algorithm and some algorithms borrowed from the adaptive FIR filter like Least Squares (LS), Least Mean Squares (LMS) and Recursive Least Squares (RLS). These methods are called equation error methods. The gradient descent algorithms are output error methods because they minimize the sum of squares of the output errors. The method worths mentioning is the hybrid method of equation and output error methods. This method establishes algorithms called the Steiglitz-McBride algorithms. Many of these algorithms are discussed in the handbook: Digital Signal Processing Handbook, CRCnetBase 1999.

In the Canadian patent data base, we see the patent CA2074782 of NEC Corporation with the title “Method of and Apparatus for Identifying Unknown System Using Adaptive Filter”. The method of adaptation of this patent is LMS. The patent CA2318929 of Nortel Networks Limited with the title “Stable Adaptive Filter and Method” relates to an IIR filter more than an FIR filter because of the concern for stability. The method of adaptation is Normalized Least Mean Squares (NLMS). The patent was applied through PCT with the PCT filing number PCT/CA1999/001068.

Most of the adaptive algorithms have a weakness and that is they adapt the zero and pole parameters together. This weakness cannot be improved. The algorithm of this invention uses the concept of the self-adjusting control algorithms of AuLac Technologies Inc., (“Methods and Devices for the Discrete Self-adjusting Controllers”, Canadian patent application number 2,656,235), which adapts the two set of parameters separately and one calculates from the other. This invention, however, improves the adaptation by factoring the pole polynomial and assures a global minimal variance of the error at each adaptation time.

### SUMMARY OF THE INVENTION

It is the object of this invention to introduce an effective algorithm to adjust the parameters of an adaptive IIR filter. The algorithm gives minimal variance of the output error.

### BRIEF DESCRIPTION OF THE DRAWINGS

FIG. 1. Block diagram of an adaptive IIR filter in system identification configuration.

### DESCRIPTION OF THE PREFERRED EMBODIMENT

This invention presents a new algorithm for the adaptation of the parameters of an adaptive IIR filter by factoring the pole polynomial and adapt the parameters of this factored polynomial by the steepest descent method. The parameters of the zero polynomial are calculated from the parameters of the pole polynomial. In the following text, we will discuss the method of adaptation of the parameters of an adaptive IIR filter of the invention.

### Method

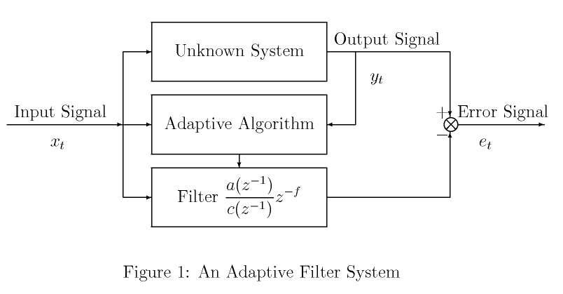

Consider the system depicted by the block diagram of FIG. 1. The system is an adaptive IIR filter system and is described by the equation

$$\begin{matrix}{y}_{t} = \frac{a ( {z}^{- 1} )}{c ( {z}^{- 1} )} {x}_{t - f} + {e}_{t} , \\ = \frac{{\sum }_{i = 0}^{m} {a}_{i} {z}^{- i}}{1 + {\sum }_{i = 1}^{n} {c}_{i} {z}^{- i}} {x}_{t - f} + {e}_{t} .\end{matrix}$$

The sum of squares of the error eₜ is given by

$${S}_{N} = {\sum }_{ }^{ } {( {y}_{t} - \frac{{\sum }_{i = 0}^{m} {a}_{i} {z}^{- i}}{1 + {\sum }_{i = 1}^{n} {c}_{i} {z}^{- i}} {x}_{t - f} )}^{2} .$$

By taking the derivatives of S_{N} with respect to the parameters aᵢ's and setting them to zeros, we get

$$\begin{matrix}\frac{\partial {S}_{N}}{\partial {a}_{i}} = 0 , \\ = - 2 {\sum }_{ }^{ } ( {y}_{t} - \frac{{\sum }_{i = 0}^{m} {\hat{a}}_{i} {z}^{- i}}{1 + {\sum }_{i = 1}^{n} {c}_{i} {z}^{- i}} {x}_{t - f} ) ( \frac{{x}_{t - f - i}}{1 + {\sum }_{i = 1}^{n} {c}_{i} {z}^{- i}} ) , \\ i = 0 , … m .\end{matrix}$$

The last equation tells an engineer that the parameters âᵢ's, optimal values of aᵢ's, should be calculated from not together with the optimal values of the parameters cᵢ's. This fact leads to the main point of this invention.

To calculate the optimal value of the step length parameter μ for the steepest descent method from the equation

c(z⁻¹)=1+(c₁−μg(c₁))z⁻¹+ . . . +(cₙ−μg(cₙ))z⁻ⁿ,

an adaptive algorithm has to ascertain that the optimal value of μ will not make the polynomial c(z⁻¹) unstable: This is a task, which is not impossible but complicated. This invention then suggests that the polynomial c(z⁻¹) is factored with the step length parameter μ as below

$$c ( {z}^{- 1} ) = [ 1 + ( {b}_{0} - μ g ( {b}_{0} ) ) {z}^{- 1} ] {\prod }_{j = 1}^{l} [ \begin{matrix}1 + ( {b}_{1 , j} - μ g ( {b}_{1 , j} ) ) {z}^{- 1} + \\ ( {b}_{2 , j} - μ g ( {b}_{2 , j} ) ) {z}^{- 2}\end{matrix} ] .$$

Analysis for stability can be readily determined from this form. This form will increase the order of μ in the equation of the derivative of the sum of squares S_{N} with respect to μ. Since the adaptive algorithm needs to calculate only the largest positive value of μ, the suggestion has a strong argument. Furthermore, if the degree is increased, more values of μ can satisfy the equation. The descent will be steeper, and this fact leads to a faster convergence to the optimal values of the pole polynomial parameters.

The global minimum of S_{N} is still an unresolved problem of an adaptive IIR filter. If the zero polynomial parameters are calculated from the pole polynomial parameters, S_{N} will be a quantity of only n pole polynomial parameters. Since N and n are finite numbers, there will be a finite number of extrema for S_{N}. It is, therefore, possible to determine the exact global minimum of S_{N} if all the extrema are known. Consider the case of two pole parameters, we can write

g₀+g₁ĉ₁+g₂ĉ₂+g₁₂ĉ₁ĉ₂+g₁₁ĉ₁²+g₂₂ĉ₂²=0,

h₀+h₁ĉ₁+h₂ĉ₂+h₁₂ĉ₁ĉ₂+h₁₁ĉ₁²+h₂₂ĉ₂²=0.

The first equation can be the result of taking the derivative of S_{N} with respect to c₁; the second equation, with respect to c₂. We will know all the extrema of S_{N} if we have all the values of the pair (ĉ₁, ĉ₂) that satisfy the last two equations. To accomplish this task, this invention suggests a method that eliminates ĉ₂ out of the two equations as follows. We write

$$[ \begin{matrix}( \begin{matrix}{g}_{0} + \\ {g}_{1} {\hat{c}}_{1} + \\ {g}_{11} {\hat{c}}_{1}^{2}\end{matrix} ) & ( {g}_{2} + {g}_{12} {\hat{c}}_{1} ) & {g}_{22} & 0 \\ 0 & ( \begin{matrix}{g}_{0} + \\ {g}_{1} {\hat{c}}_{1} + \\ {g}_{11} {\hat{c}}_{1}^{2}\end{matrix} ) & ( {g}_{2} + {g}_{12} {\hat{c}}_{1} ) & {g}_{22} \\ ( \begin{matrix}{h}_{0} + \\ {h}_{1} {\hat{c}}_{1} + \\ {h}_{11} {\hat{c}}_{1}^{2}\end{matrix} ) & ( {h}_{2} + {h}_{12} {\hat{c}}_{1} ) & {h}_{22} & 0 \\ 0 & ( \begin{matrix}{h}_{0} + \\ {h}_{1} {\hat{c}}_{1} + \\ {h}_{11} {\hat{c}}_{1}^{2}\end{matrix} ) & ( {h}_{2} + {h}_{12} {\hat{c}}_{1} ) & {h}_{22}\end{matrix} ] [ \begin{matrix}1 \\ {\hat{c}}_{2} \\ {\hat{c}}_{2}^{2} \\ {\hat{c}}_{2}^{3}\end{matrix} ] = 0 ,$$

then obtain all the optimal values ĉ₁'s that satisfy the equation

$$\vert \begin{matrix}( \begin{matrix}{g}_{0} + \\ {g}_{1} {\hat{c}}_{1} + \\ {g}_{11} {\hat{c}}_{1}^{2}\end{matrix} ) & ( {g}_{2} + {g}_{12} {\hat{c}}_{1} ) & {g}_{22} & 0 \\ 0 & ( \begin{matrix}{g}_{0} + \\ {g}_{1} {\hat{c}}_{1} + \\ {g}_{11} {\hat{c}}_{1}^{2}\end{matrix} ) & ( {g}_{2} + {g}_{12} {\hat{c}}_{1} ) & {g}_{22} \\ ( \begin{matrix}{h}_{0} + \\ {h}_{1} {\hat{c}}_{1} + \\ {h}_{11} {\hat{c}}_{1}^{2}\end{matrix} ) & ( {h}_{2} + {h}_{12} {\hat{c}}_{1} ) & {h}_{22} & 0 \\ 0 & ( \begin{matrix}{h}_{0} + \\ {h}_{1} {\hat{c}}_{1} + \\ {h}_{11} {\hat{c}}_{1}^{2}\end{matrix} ) & ( {h}_{2} + {h}_{12} {\hat{c}}_{1} ) & {h}_{22}\end{matrix} \vert = 0 ,$$

which is a polynomial equation in ĉ₁. By putting these values in the two original equations, we can obtain all the optimal values ĉ₂'s. All the extremal values of S_{N} will be known, and we can determine the value of the pair (ĉ₁, ĉ₂) that gives the minimal value of S_{N}. The same procedure can be followed when c(z⁻¹) has more than two parameters. At each time of adaptation, the algorithm can determine the exact global minimum in this manner. However, since more data means higher orders for the parameters, the algorithm can determine the global minimum with less data then successively adjust the parameters with new data. This establishes the adaptive algorithm with assured global minimum.

Adaptation with a forgetting factor 0<λ≦1 can be carried out in the same manner by searching for the global minimum of

$${S}_{N} = {\sum }_{t}^{N} {{λ}^{N - t} ( {y}_{t} - \frac{{\sum }_{i = 0}^{m} {a}_{i} {z}^{- i}}{1 + {\sum }_{i = 1}^{n} {c}_{i} {z}^{- i}} {x}_{t - f} )}^{2} .$$

### INDUSTRIAL APPLICATIONS

The adaptive IIR filter has so many industrial applications that prompts researchers to work on algorithms to perfect the on-line adaptation of its parameters. Its applications include linear prediction, adaptive notch filtering, adaptive differential pulse code modulation, channel equalization, echo cancellation and adaptive array processing. These applications are so well known that it is not necessary to provide an industrial example to prove the usefulness of the invention.

### IMPLEMENTATION

Implementation of the adaptive IIR filter usually takes the form of a digital chip, notably the DSP (digital signal processor). A DSP is a special microprocessor with some special instructions for efficiency. For most applications, however, the adaptive IIR filter can be materialized with a microcontroller and the software can be either in assembly language or C. The following code in Matlab language of The MathWorks, Inc., which can be converted to C and downloaded into a microcontroller, is part of the software used to test the adaptive algorithm.

%
% Define the necessary parameters and variables here
%
...
%
% Then start the algorithm
%
[c]=getInitialValuesC(yt,xt,lambda);
for t=startTime:endTime

[yN,XN,C1,C2,Lambda1,Lambda2]=setupMatrices(c,yt,xt,lambda);
[g,b]=getGradients(yN,XN,c,C1,C2,Lambda1,Lambda2);
[b]=getNewFactoredPoles(g,b);
[c]=getPoleParameters(b);
[a]=getZeroParameters(yN,XN,C1,C2,Lambda1,Lambda2);

end;

What I claim as my invention is:

1. A method to design and set up variables for the adaptive IIR filter with the following transfer function:
$$\begin{matrix}{y}_{t} = \frac{a ( {z}^{- 1} )}{c ( {z}^{- 1} )} {x}_{t - f} + {e}_{t} , \\ = \frac{{\sum }_{i = 0}^{m} {a}_{i} {z}^{- i}}{1 + {\sum }_{i = 1}^{n} {c}_{i} {z}^{- i}} {x}_{t - f} + {e}_{t}\end{matrix}$$
for minimal variance of the output error eₜ weighted with a forgetting factor 0<λ≦1, which consists of the following steps:
(a) factoring the filter's pole polynomial as
$$c ( {z}^{- 1} ) = ( 1 + {b}_{0} {z}^{- 1} ) {\prod }_{j = 1}^{l} ( 1 + {b}_{1 , j} {z}^{- 1} + {b}_{2 , j} {z}^{- 2} ) ,$$
(b) setting up appropriate matrices and vectors of the variables, in the beginning and at each adaptation time t, for the said filter as below
$${C}_{1} = [ \begin{matrix}{c}_{l} & ⋯ & {c}_{1} \\ & ⋱ & ⋮ \\ & & {c}_{l} \\ & ⋮ & \\ & 0 & \\ & ⋮ & \end{matrix} ]$$
$${C}_{2} = [ \begin{matrix}1 & & & & & \\ ⋮ & 1 & & & & \\ {c}_{l} & ⋯ & 1 & & & \\ & ⋱ & ⋱ & ⋱ & & \\ & & ⋱ & ⋱ & ⋱ & \\ & & & {c}_{l} & ⋯ & 1\end{matrix} ] c = [ \begin{matrix}{c}_{1} \\ ⋮ \\ {c}_{l}\end{matrix} ] {X}_{t} = [ \begin{matrix}{x}_{{t}_{0}} \\ {x}_{{t}_{0} + 1} \\ ⋮ \\ ⋮ \\ ⋮ \\ {x}_{t}\end{matrix} ] {y}_{t} = [ \begin{matrix}{y}_{{t}_{0} - l} \\ ⋮ \\ {y}_{{t}_{0}} \\ ⋮ \\ ⋮ \\ {y}_{t}\end{matrix} ]$$
with
Xₜ=[χ_{t-f}χ_{t-f-1} . . . χ_{t-f-m}],
(c) setting up the variance of the output error eₜ at the time t as
$${V}_{t} ( c ) = \frac{1}{t} {lim .}_{ɛ \to 0} {{y}_{t}^{T} [ \begin{matrix}{C}_{1}^{T} \\ {C}_{2}^{T}\end{matrix} ] [ {C}_{1} {C}_{1}^{T} + {C}_{2} {C}_{2}^{T} + \frac{{X}_{t} {X}_{t}^{T}}{ɛ} ]}^{- 1} [ \begin{matrix}{C}_{1} & {C}_{2}\end{matrix} ] {y}_{t}$$
$$if λ = 1 or$$
$${V}_{t} ( c ) = \frac{1}{t} {lim .}_{ɛ \to 0}$$
$${{y}_{t}^{T} [ \begin{matrix}{C}_{1}^{T} \\ {C}_{2}^{T}\end{matrix} ] [ {C}_{1} {Λ}_{1}^{- 1} {C}_{1}^{T} + {C}_{2} {Λ}_{2} {C}_{2}^{T} + \frac{{X}_{t} {X}_{t}^{T}}{ɛ} ]}^{- 1} [ \begin{matrix}{C}_{1} & {C}_{2}\end{matrix} ] {y}_{t}$$
$$and$$
$${Λ}_{1} = [ \begin{matrix}{λ}^{k + l - 1} & & \\ & ⋱ & \\ & & {λ}^{k}\end{matrix} ] , {Λ}_{2} = {[ \begin{matrix}{λ}^{k - 1} & & & & & \\ & ⋱ & & & & \\ & & ⋱ & & & \\ & & & {λ}^{2} & & \\ & & & & λ & \\ & & & & & 1\end{matrix} ]}^{- 1}$$
with k as the dimension of C₂ otherwise.

2. A method to obtain the two real-valued parameters of a positive polynomial function ƒ(c₁, c₂) of these parameters that give the minimal value for the function, which consists of the following steps:
(a) setting the derivatives of ƒ(c₁, c₂) with respect to the parameters to zeros to produce two polynomial equations in two parameters:
$${g}_{1} ( {c}_{1} , {c}_{2} ) = \frac{\partial f ( {c}_{1} , {c}_{2} )}{\partial {c}_{1}} = {\sum }_{k = 0} {\sum }_{l = 0} {a}_{k , l} {c}_{1}^{k} {c}_{2}^{l} = 0$$
$${g}_{2} ( {c}_{1} , {c}_{2} ) = \frac{\partial f ( {c}_{1} , {c}_{2} )}{\partial {c}_{2}} = {\sum }_{k = 0} {\sum }_{l = 0} {b}_{k , l} {c}_{1}^{k} {c}_{2}^{l} = 0 ,$$
(b) eliminating the parameter c₂ by setting up the following equation
$$[ {\sum }_{i = 0}^{r} {c}_{1}^{i} {C}_{i} ] [ \begin{matrix}1 \\ {c}_{2} \\ {c}_{2}^{2} \\ ⋮\end{matrix} ] = 0$$
with values of the matrices Cᵢ's obtained from the two equations produced in step (a),
(c) obtaining all the real-valued roots, c_{1,real}, of the parameters c₁ to satisfy the equation
$$\vert {\sum }_{i = 0}^{r} {c}_{1}^{i} {C}_{i} \vert = 0$$
which results from the equation produced in step (b),
(d) producing a list of real-valued pairs (c_{1,real}, C_{2,real}) by putting a value c_{1,real} obtained in step (c) into the two equations produced in step (a) and obtaining the common real-valued c_{2,real} of the two equations,
(e) obtaining the pair of (c_{1,real}, c_{2,real}) that gives ƒ(c₁, c₂) the minimal value by putting all sets of real-valued parameters into ƒ(c₁, c₂) and comparing their values.

3. A method to obtain the n real-valued parameters of a positive polynomial function ƒ(c) of these parameters that give the minimal value for the function, which consists of the following steps:
(a) setting the derivatives of ƒ(c) with respect to the parameters to zeros to produce n polynomial equations in n parameters:
$$\frac{\partial f ( c )}{\partial {c}_{i}} = {\sum }_{{j}_{1} = 0} ⋯ {\sum }_{{j}_{n} = 0} {a}_{{j}_{1} , ⋯ {j}_{n}}^{( i , n )} {c}_{1}^{{j}_{1}} ⋯ {c}_{n}^{{j}_{n}} = 0 , i = 1 , ⋯ n$$
(b) eliminating the parameter cₙ to produce n−1 following equations:
$${\sum }_{{j}_{1} = 0} ⋯ {\sum }_{{j}_{n - 1} = 0} {a}_{{j}_{1} , ⋯ {j}_{n - 1}}^{( i , n - 1 )} {c}_{1}^{{j}_{1}} ⋯ {c}_{n - 1}^{{j}_{n - 1}} = 0 , i = 1 , ⋯ n - 1 ,$$
(c) repeating step (b) until n=3 each time with a decrease in number of parameters and equations,
(d) obtaining a list of extremal real-valued pairs (c_{1,real}, c_{2,real}) from their two corresponding equations as described in claim 2,
(e) putting pairs of values of (c_{1,real}, c_{2,real}) into the three equations produced in steps (b) and (c) and obtaining the common real-valued c_{3,real} of the three equations,
(f) obtaining all the extremal real-valued parameters by repeating step (e) each time with an increase in number of parameters and equations,
(g) obtaining the set of all n real-valued parameters that gives ƒ(c) the minimal value by putting all sets of real-valued parameters into the function ƒ(c) and comparing their values.

4. A method to adapt the parameters, at the adaptation time N, of an adaptive IIR filter with the transfer function
$${y}_{t} = \frac{{\sum }_{i = 0}^{m} {a}_{i} {z}^{- i}}{1 + {\sum }_{i = 1}^{m} {c}_{i} {z}^{- i}} {x}_{t - f} + {e}_{t}$$
for minimal variance of the output error eₜ, which consists of the following steps:
(a) determining the parameters ĉₖ's as the optimal values of cₖ's for the function
$${V}_{N} ( c ) = \frac{1}{N} {lim .}_{ɛ \to 0} {{y}_{N}^{T} [ \begin{matrix}{C}_{1}^{T} \\ {C}_{2}^{T}\end{matrix} ] [ {C}_{1} {C}_{1}^{T} + {C}_{2} {C}_{2}^{T} + \frac{{X}_{N} {X}_{N}^{T}}{ɛ} ]}^{- 1} [ \begin{matrix}{C}_{1} & {C}_{2}\end{matrix} ] {y}_{N}$$
to have the minimal value by the methods described in claim 2 or 3 if it is the first time for adaptation then jumping to step (i) or following from step (b) to step (i) otherwise,
(b) obtaining the values b_{0,N}⁰, b_{1,j,N}⁰'s and b_{1,j,N}⁰'s as the optimal values \hat{b}_{0,N-1}, \hat{b}_{1,j,N-1}'s and \hat{b}_{2,j,N-1}'s from the last adaptation time if they are available or factoring the polynomial c(z⁻¹) to obtain these parameters as shown in the equation in step (a) of claim 1 otherwise,
(c) proposing the new values of the parameters of the pole polynomial at iteration k as
b_{0,N}^{k}=b_{0,N}^{k-1}−μg_{N}(b_{0,N}^{k-1})
b_{1,j,N}^{k}=b_{1,j,N}^{k-1}−μg_{N}(b_{1,j,N}^{k-1}), j=1, . . . l
b_{2,j,N}^{k}=b_{2,j,N}^{k-1}−μg_{N}(b_{2,j,N}^{k-1}), j=1, . . .
with g_{N}(b_{0,N}^{k-1}) as the derivative of V_{N}(c) with respect to b₀ and evaluated at the value b_{0,N}^{k-1} and similarly for the other parameters,
(d) obtaining the polynomial c(z⁻¹) as a function of the step length parameter μ with the equation given in step (a) of claim 1 and the parameters given in step (c),
(e) obtaining the largest positive and stable value, \hat{μ}, of the step length parameter μ for the quantity V_{N} (C) a function of only the parameter μ, to have the minimal value with all the matrices and vectors set up as shown in claim 1 and the parameters of c(z⁻¹) in C₁ and C₂ obtained in step (c),
(f) calculating the parameters b_{0,N}^{k}, b_{1,j,N}^{k}'s and b_{2,j,N}^{k}'s with this value of \hat{μ} and with the equations given in step (c),
(g) repeating the steps from (b) to (f) until convergence and accepting the finally calculated values as the optimal values \hat{b}_{0,N}, \hat{b}_{1,j,N}'s and \hat{b}_{2,j,N}'s,
(h) obtaining the parameters ĉₖ as the optimal value of cₖ of the pole polynomial from the following equation
$${{\hat{c}}_{k} = \frac{{d}^{k} ( 1 + {\hat{b}}_{0 , N} {z}^{- 1} ) {\prod }_{j = 1}^{l} ( 1 + {\hat{b}}_{1 , j , N} {z}^{- 1} + {\hat{b}}_{2 , j , N} {z}^{- 2} )}{k ! {d ( {z}^{- 1} )}^{k}} \vert}_{{z}^{- 1} = 0} ,$$
(i) obtaining the optimal parameters of the zero polynomial from the following equation
$$[ \begin{matrix}{\hat{a}}_{0} \\ {\hat{a}}_{1} \\ ⋮ \\ {\hat{a}}_{m}\end{matrix} ] = {[ \begin{matrix}I & 0\end{matrix} ] [ [ \begin{matrix}0 & 0 \\ 0 & I\end{matrix} ] + [ \begin{matrix}{X}_{N}^{T} \\ {C}_{1}^{T}\end{matrix} ] {( {C}_{2} {C}_{2}^{T} )}^{- 1} [ \begin{matrix}{X}_{N} & {C}_{1}\end{matrix} ] ]}^{- 1} \\ [ \begin{matrix}{X}_{N}^{T} \\ {C}_{1}^{T}\end{matrix} ] {( {C}_{2} {C}_{2}^{T} )}^{- 1} [ \begin{matrix}{C}_{1} & {C}_{2}\end{matrix} ] {y}_{N}$$
with the parameters of the pole polynomial c(z⁻¹) in the matrices C₁ and C₂ determined from step (h) or from the initialization step described in step (a).

5. A method to adapt the parameters, at the adaptation time N, of an adaptive IIR filter with the transfer function
$${y}_{t} = \frac{{\sum }_{i = 0}^{m} {a}_{i} {z}^{- i}}{1 + {\sum }_{i = 1}^{m} {c}_{i} {z}^{- i}} {x}_{t - f} + {e}_{t}$$
for minimal variance of the output error eₜ weighted with a forgetting factor 0<λ≦1, which consists of the following steps:
(a) determining the parameters ĉₖ's as the optimal values of cₖ's for the function
$${V}_{N} ( c ) = \frac{1}{N} {lim .}_{ɛ \to 0}$$
$${{y}_{N}^{T} [ \begin{matrix}{C}_{1}^{T} \\ {C}_{2}^{T}\end{matrix} ] [ {C}_{1} {Λ}_{1}^{- 1} {C}_{1}^{T} + {C}_{2} {Λ}_{2} {C}_{2}^{T} + \frac{{X}_{N} {X}_{N}^{T}}{ɛ} ]}^{- 1} [ \begin{matrix}{C}_{1} & {C}_{2}\end{matrix} ] {y}_{N}$$
to have the minimal value by the methods described in claim 2 or 3 if it is the first time for adaptation then jumping to step (i) or following from step (b) to step (i) otherwise,
(b) obtaining the values b_{0,N}⁰, b_{1,j,N}⁰'s and b_{1,j,N}⁰'s as the optimal values \hat{b}_{0,N-1}, \hat{b}_{1,j,N-1}'s and \hat{b}_{2,j,N-1}'from the last adaptation time if they are available or factoring the polynomial c(z⁻¹) to obtain these parameters as shown in the equation in step (a) of claim 1 otherwise,
(c) proposing the new values of the parameters of the pole polynomial at iteration k as
b_{0,N}^{k}=b_{0,N}^{k-1}−μg_{N}(b_{0,N}^{k-1})
b_{1,j,N}^{k}=b_{1,j,N}^{k-1}−μg_{N}(b_{1,j,N}^{k-1}), j=1, . . . l
b_{2,j,N}^{k}=b_{2,j,N}^{k-1}−μg_{N}(b_{2,j,N}^{k-1}), j=1, . . . l
with g_{N}(b_{0,N}^{k-1}) as the derivative of V_{N}(c) with respect to b₀ and evaluated at the value b_{0,N}^{k-1} and similarly for the other parameters,
(d) obtaining the polynomial c(z⁻¹) as a function of the step length parameter μ with the equation given in step (a) of claim 1 and the parameters given in step (c),
(e) obtaining the largest positive and stable value, \hat{μ}, of the step length parameter μ for the quantity V_{N} (C) a function of only the parameter μ, to have the minimal value with all the matrices and vectors set up as shown in claim 1 and the parameters of c(z⁻¹) in C₁ and C₂ obtained in step (c),
(f) calculating the parameters b_{0,N}^{k}, b_{1,j,N}^{k}'s and b_{2,j,N}^{k}'s with this value of \hat{μ} and with the equations given in step (c),
(g) repeating the steps from (b) to (f) until convergence and accepting the finally calculated values as the optimal values \hat{b}_{0,N}, \hat{b}_{1,j,N}'s and \hat{b}_{2,j,N}'s,
(h) obtaining the parameters ĉₖ as the optimal value of cₖ of the pole polynomial from the following equation
$${{\hat{c}}_{k} = \frac{{d}^{k} ( 1 + {\hat{b}}_{0 , N} {z}^{- 1} ) {\prod }_{j = 1}^{l} ( 1 + {\hat{b}}_{1 , j , N} {z}^{- 1} + {\hat{b}}_{2 , j , N} {z}^{- 2} )}{k ! {d ( {z}^{- 1} )}^{k}} \vert}_{{z}^{- 1} = 0} ,$$
(i) obtaining the optimal parameters of the zero polynomial from the following equation
$$[ \begin{matrix}{\hat{a}}_{0} \\ {\hat{a}}_{1} \\ ⋮ \\ {\hat{a}}_{m}\end{matrix} ] = {[ \begin{matrix}I & 0\end{matrix} ] [ [ \begin{matrix}0 & 0 \\ 0 & {Λ}_{1}\end{matrix} ] + [ \begin{matrix}{X}_{N}^{T} \\ {C}_{1}^{T}\end{matrix} ] {( {C}_{2} {Λ}_{2} {C}_{2}^{T} )}^{- 1} [ \begin{matrix}{X}_{N} & {C}_{1}\end{matrix} ] ]}^{- 1} \\ [ \begin{matrix}{X}_{N}^{T} \\ {C}_{1}^{T}\end{matrix} ] {( {C}_{2} {Λ}_{2} {C}_{2}^{T} )}^{- 1} [ \begin{matrix}{C}_{1} & {C}_{2}\end{matrix} ] {y}_{N}$$
with the parameters of the pole polynomial c(z⁻¹) in the matrices C₁ and C₂ determined from step (h) or from the initialization step described in step (a).
